(19) United States
(12) Patent Application Publication
(10) Pub. No.: US 2018/0353907 A1
(43) Pub. Date: Dec. 13, 2018

(54) Purification of Lithium-Containing Brine

(71) Applicant: ALBEMARLE CORPORATION, Baton Rouge, LA (US)

(72) Inventors: Jackson R. Switzer, Kings Mountain, NC (US); Chi Hung Cheng, Baton Rouge, LA (US); Steven R. Alferi, Baton Rouge, LA (US)

(21) Appl. No.: 15/736,540

(22) PCT Filed: Oct. 16, 2015
(86) PCT No.: PCT/US2015/056097

§ 371 Date: Dec. 14, 2017

Related U.S. Application Data
(60) Provisional application No. 62/183,786, filed on Jun. 24, 2015.

(51) Int. Cl. B01D 61/02; B01D 71/16; B01J 20/28

(52) U.S. Cl. CPC B01D 61/022; B01D 71/16; B01D 61/027; B01D 2317/025; B01D 2311/25; B01D 2317/022; B01J 20/28035

(57) ABSTRACT

A process for removing at least Ca²⁺ and Mg²⁺ from a lithium-containing brine. The process comprises (i) providing an aqueous lithium-containing brine feed comprising dissolved Ca²⁺ and Mg²⁺ impurities in a weight ratio of Li⁺:Ca²⁺ of about 4:1 to 50:1 wt/wt and in a weight ratio of Li⁺:Mg²⁺ of about 4:1 to 50:1; (ii) subjecting said brine feed to nanofiltration to produce a lithium-containing permeate from which Ca²⁺ and Mg²⁺ components are being removed concurrently; and (iii) conducting the nanofiltration so that a separation occurs and a retentate solution is formed with a total amount of Ca²⁺ and Mg²⁺ of at least 75% of the total amount of Ca²⁺ and Mg²⁺ in the original aqueous lithium-containing brine feed and forming an aqueous lithium-containing permeate solution in which the total content of dissolved Ca²⁺ and Mg²⁺ is decreased to 25% or less as compared to the original aqueous lithium-containing brine feed.

### TECHNICAL FIELD

This disclosure relates to economically and technologically attractive process technology for recovering lithium or its salts from suitable readily available aqueous lithium-containing sources. More particularly, improved methods for separating at least Ca²⁺ and Mg²⁺ species from suitable aqueous lithium-containing brine solutions are featured.

### BACKGROUND

In recent years a need has arisen for more economical and efficient technology enabling production of lithium or its salts from suitable sources. This is reflected by an increase in research activities devoted to this subject. And it appears that this need has not been fulfilled yet by any published prior art.

### BRIEF NON-LIMITING SUMMARY OF THE INVENTION

This invention provides process technology which is deemed to be an important step forward in the development of more efficient, economical, and environmentally-desirable technology for recovering lithium values from suitable lithium-containing brine sources. More particularly, in one of its embodiments this invention provides an economically and technologically attractive way of removing Ca²⁺ and Mg²⁺ salts from lithium-containing aqueous sources that comprise as impurities at least these divalent species in solution in suitable ratios and preferably in suitable concentrations that enable them to be removed concurrently from the lithium-containing brine source being utilized. Moreover, the manner in which the Ca²⁺ and Mg²⁺ species are concurrently removed is economically desirable and in preferred embodiments is also especially environmentally desirable.

As used in the present disclosure the following terms have the following meanings:
Nanofiltration is a pressure-driven membrane separation process that forms the transition between ultrafiltration and reverse osmosis. Nanofiltration is applicable to separate particles ranging from about 10⁻³ to 10⁻² microns in size; that is, particles in a size range between those separable by reverse osmosis and ultrafiltration.
Permeate solution is the solution which passes through the nanofiltration membrane.
Retentate solution is the solution which contains the nanofiltration contents which have not passed through the nanofiltration membrane.

In one of its embodiments this invention provides a process for removing divalent ions comprised at least of Ca²⁺ and Mg²⁺ from a lithium-containing brine, which process comprises
(i) providing an aqueous lithium-containing brine feed comprising at least Ca²⁺ and Mg²⁺ impurities in solution and in a weight ratio of dissolved Li⁺:Ca²⁺ in the range of about 4:1 to 50:1 wt/wt and in weight ratios of dissolved Li⁺:Mg²⁺ in the range of about 4:1 to about 50:1;
(ii) subjecting said lithium-containing brine feed to nanofiltration to produce a lithium-containing permeate from which Ca²⁺ and Mg²⁺ components are being removed concurrently; and
(iii) conducting the nanofiltration to cause a separation in which a retentate solution is formed with a total amount of Ca²⁺ and Mg²⁺ of at least 75% as compared to the total amount Ca²⁺ and Mg²⁺ in the original aqueous lithium-containing brine feed and forming an aqueous lithium-containing permeate solution in which the total content of dissolved Ca²⁺ and Mg²⁺ has been decreased such that the total content thereof is 25% or less as compared to the original aqueous lithium-containing brine feed.

The above process is preferably conducted whereby the aqueous lithium-containing brine used as the feed in (i) has an initial content of at least 200 ppm (wt/wt) of Li⁺, an initial content of Ca²⁺ of at least 25 ppm (wt/wt) and an initial content of Mg²⁺ of at least about 25 ppm (wt/wt), and more preferably whereby the feed in (i) has an initial content of at least 500 ppm (wt/wt) of Li⁺, an initial content of Ca²⁺ of at least 25 ppm (wt/wt) and an initial content of Mg²⁺ of at least about 25 ppm (wt/wt). Still more preferably, the feed in (i) has an initial content of at least 1000 ppm (wt/wt) of Li⁺, an initial content of Ca²⁺ of at least 50 ppm (wt/wt) and an initial content of Mg²⁺ of at least about 50 ppm (wt/wt).

Another characteristic of the lithium-containing brine feed used in the practice of this invention is that they be amenable to nanofiltration. By this is meant that the lithium-containing brine feed is free of components which would prematurely foul the particular nanofiltration membranes being utilized in the nanofiltration units employed in the process. Generally speaking, a desirable effective service life for a membrane used in the practice of this invention is at least 4 years.

Brine feeds of this invention having a chloride ion concentration as high as 10,000 ppm have been successfully utilized in processing in accordance with this invention. Therefore, the chloride ion concentration in the feed brine may be at least as high as about 1,500 to 15,000 ppm, if not higher.

Typically, nanofiltration is conducted using at least one series of two or more nanofiltration units arranged in series or wherein the nanofiltration is conducted using at least two or more nanofiltration units arranged in parallel. Although various different membranes can be employed, desirably, the nanofiltration membranes contained in the nanofiltration units are cellulose acetate membranes or are composed of at least one thin polyamide layer deposited on a polyethersulfone porous layer or a polysulfone porous layer.

The above and other embodiments, features, and advantages of this invention will become still further apparent from the ensuing description and the appended claims.

### BRIEF DESCRIPTION OF THE DRAWINGS

FIG. 1 depicts a standard laboratory testing apparatus for conducting nanofiltration.

FIG. 2 depicts a plot of data obtained in Example 1 of this disclosure.

FIG. 3 provides a summary of data obtained in a laboratory test described in Example 2 which simulates a series of operations with dilution of the feed stream between each stage of operation.

FIG. 4 depicts graphically the results of sampling of a composite sampled from a permeate flask in a laboratory operation.

FIG. 5 depicts the flux through the nanofiltration membrane utilized in Example 2.

FIG. 6 depicts projected staging and dilution in a nanofiltration process based on laboratory studies.

### FURTHER DETAILED DESCRIPTION OF THE INVENTION

The present invention provides a waste-free, efficient process for removing divalent ion impurities from lithium-containing brine streams. In the process, nanofiltration technology is used to produce two streams, viz., 1) a divalent-rich impurity stream (retentate) and 2) a nearly divalent-free lithium-rich product stream (permeate). The present process is deemed to constitute a significant improvement over the current state of the art because no consumable raw materials are required and no waste is generated. The divalent-rich impurity stream is suitable for safe-return to the environment.

Indeed, the present nanofiltration purification process has several significant advantages over the current state of the art. The advantages of the invented process can be more fully summarized into two key points.

### 1. No Solid Waste Generation

Conventional practice typically calls for removal of divalent ions through precipitation. Divalent removal by precipitation generates substantial quantities of solid waste. In the present lithium recovery process, solid waste generation using the conventional precipitation practice can be on the order of 180 kg of calcium carbonate solids and 132 kg of magnesium hydroxide solids for every metric ton of lithium carbonate product produced.

As noted above, two streams are generated by the present nanofiltration process i.e., 1) a divalent-rich impurity stream (retentate), and 2) a nearly divalent-free lithium-rich product stream (permeate). Key to avoiding solid waste generation is that the divalent ions in the retentate remain soluble and do not change in chemical composition. Because of this, the stream can easily be returned to the environment without solids generation and without requiring waste handling.

### 2. No Consumable Raw Materials Required

The aforementioned conventional precipitation practice for divalent ion removal typically requires a base such as lime, sodium carbonate and sodium hydroxide to convert the soluble calcium chloride and magnesium chloride salts to insoluble calcium and magnesium salts. An equimolar quantity of the base relative to the corresponding soluble calcium chloride and magnesium chloride salt is required. In the present lithium recovery process from especially preferred brines, for every metric ton of lithium carbonate produced, about 0.2 metric tons of the base would be required.

The present process does not require any consumable raw materials (outside of process equipment maintenance and potentially cleaning chemicals). This reduction in raw materials provides a significant cost savings in the overall cost per lb of lithium production (>10%).

The overarching feature of the present nanofiltration process is its capability of removing at least about 75% and preferably greater than 85% of divalent impurities (magnesium and calcium) from a lithium-containing brine stream. As part of an overall lithium recovery process from a suitable lithium-containing brine, removal of divalent ions is critical to establishing the required purity of the final lithium carbonate/lithium hydroxide product.

In the present process, nanofiltration is used to remove divalent ions from a lithium-containing brine stream, having the ratios and preferably the concentrations of Li⁺, Ca²⁺, and Mg²⁺ specified above. The process operates by passing the lithium-containing brine stream that contains divalent impurities (Stream A) through a nanofiltration unit. Stream A—retentate—contacts one side of a nanofiltration membrane in the unit. Under modest pressure (between 100 and 500 psig) and flow, water is caused to flux from Stream A through the membrane to produce a permeate stream (Stream B). Along with water, Stream B contains monovalent ions, specifically lithium and sodium (˜90%), which permeate through the membrane under the operating conditions. Divalent impurities—to include magnesium and calcium ions—however, do not readily permeate through the membrane as they remain in Stream A (preferably greater than 85%), effectively providing a separation between monovalent lithium ions and divalent calcium and magnesium ions. It should be noted that flux across the membrane increases with temperature. While it is preferred to operate the process at temperatures between 30 and 90° C., the process is theoretically feasible at a wide range of temperatures. Further, the process can be operated at a wide range of pressures and flows, depending on the flux and recovery desired.

The present process can be operated in a number of series or parallel configurations to accomplish the desired level of separation while maintaining a constant flux through the membrane. This invention includes single-pass operation, multiple-pass recirculation, and series configurations for removing divalent ions from suitable lithium-containing brine streams. Moreover, as shown in Examples 2 and 3 hereinafter, it is possible pursuant to this invention to maintain a constant flux across the membrane. To accomplish this desirable feature, water produced in a subsequent reverse osmosis unit operation is recycled back to the nanofiltration process run in series. In between each stage in the nanofiltration series, water is added to Stream A—retentate—to maintain a near constant salt concentration in the stream and concordantly to allow for a constant flux of lithium and water across the membrane.

The lithium-containing brine utilized in the practice of this invention can be derived from any suitable source such as seawater or lake, river, or subterranean aqueous sources containing at least Li⁺, Ca²⁺, and Mg²⁺.

One preferred potential source of lithium in the United States is the Smackover formation which to date has not been utilized commercially as an initial source of lithium-containing brine for recovery of its lithium content. U.S. Pat. Nos. 8,287,829; 8,309,043; 8,435,468; 8,574,519; 8,637,428; 8,741,256; and 9,012,357 all refer to the Smackover formation as a source for lithium values. Yet despite these and other efforts to achieve this objective, it appears that provision of commercially satisfactory technology for making use of Smackover brine or other subterranean sources as the source for lithium values have not been accomplished. So far as is known, the only successful commercial use of Smackover brine is as a source of elemental bromine. It is believed not unreasonable to suggest that the presently-described technology may play a role in the successful utilization of Smackover brine as a source of lithium values, such as lithium carbonate for battery usage.

If in its normal state the lithium-containing brine source, such as Smackover brine, requires processing to adjust the ratios and/or concentrations of any of Li⁺, Ca²⁺, and Mg²⁺ to achieve the specified ratios and/or concentrations specified herein for the lithium-containing brine source provided as the feed to the process, known procedures may be used to effect the appropriate suitable adjustments. Examples of such known processing are reverse osmosis, forward osmosis, adsorption, and precipitation or combinations of at least two of such procedures. Naturally, economic considerations will apply as much as technical considerations.

Examples 1-3 are illustrative demonstrations of the nanofiltration technology of this invention, and are not intended to limit the scope of this invention to only the procedure and details set forth therein.

### EXAMPLE 1

In a laboratory scale operation, a salt solution—Stream A, permeate—containing LiCl, NaCl, CaCl₂, MgCl₂, and B(OH)₃ was recirculated through a nanofiltration membrane testing apparatus under a pressure of 250 psig and a flow of 1.5 L/min. A commercially available nanofiltration membrane (GE Osmonics CK membrane, publicly indicated to be a triacetate/diacetate blend that has a higher flux and better mechanical stability than standard cellulose acetate) was used. Temperature was maintained at less than 30° C. The recirculating solution contacted one side of a nanofiltration membrane. As the solution recirculated permeate—Stream B—was collected from the alternate side of the membrane. The permeate weight over time was collected to calculate flux through the membrane. The initial and ending compositions of Streams A and B are shown in Table 1.

TABLE 1
Start and End Compositions of Streams A and B

| | | Solution | LiCl | NaCl | CaCl | MgCl | B(OH) |
|---|---|---|---|---|---|---|---|
| Stream | Time | (g) | (g) | (g) | (g) | (g) | (g) |
| Stream A | Start | 2020.4 | 28.22 | 17.45 | 1.34 | 2.18 | 0.34 |
| Stream A | End | 473.5 | 10.75 | 6.09 | 1.17 | 1.94 | 0.06 |
| Stream B | Start | 0 | 0 | 0 | 0 | 0 | 0 |
| Stream B | End | 1546.9 | 17.47 | 11.36 | 0.17 | 0.24 | 0.28 |

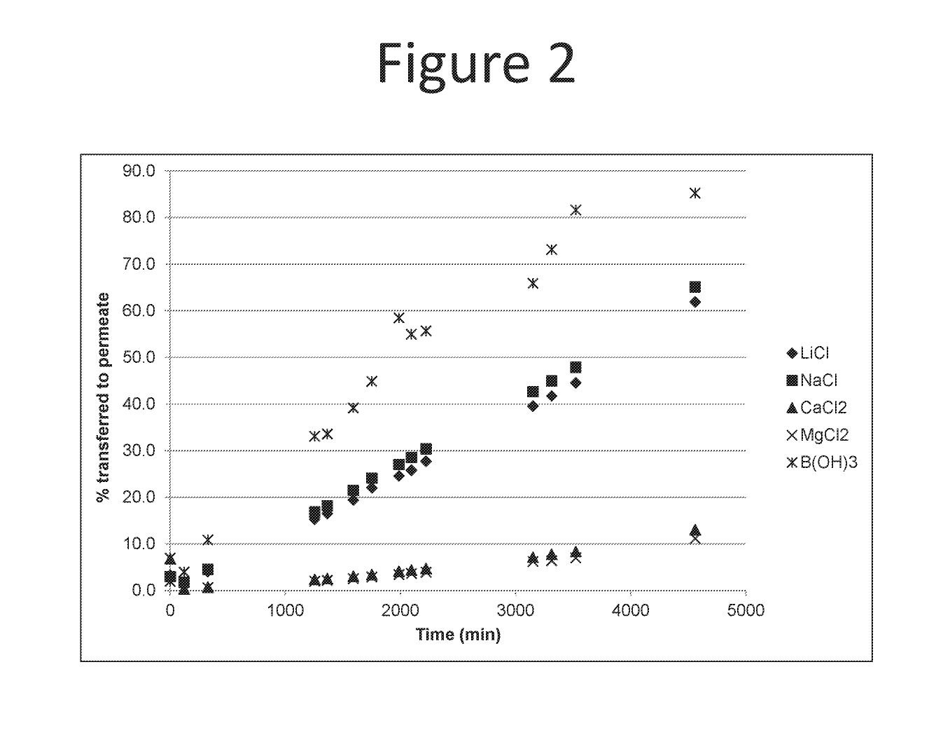

Overall 77% of the starting mass was collected as permeate (Stream B). As shown in FIG. 2, greater than 60% of the monovalent ions (lithium and sodium) were transferred to the permeate Stream B. Conversely, less than 15% of the divalent ions in Stream A were transferred to Stream B. The data shown does not represent the final attainable recovery, the experiment was stopped prior to endpoint due to time considerations.

### EXAMPLE 2

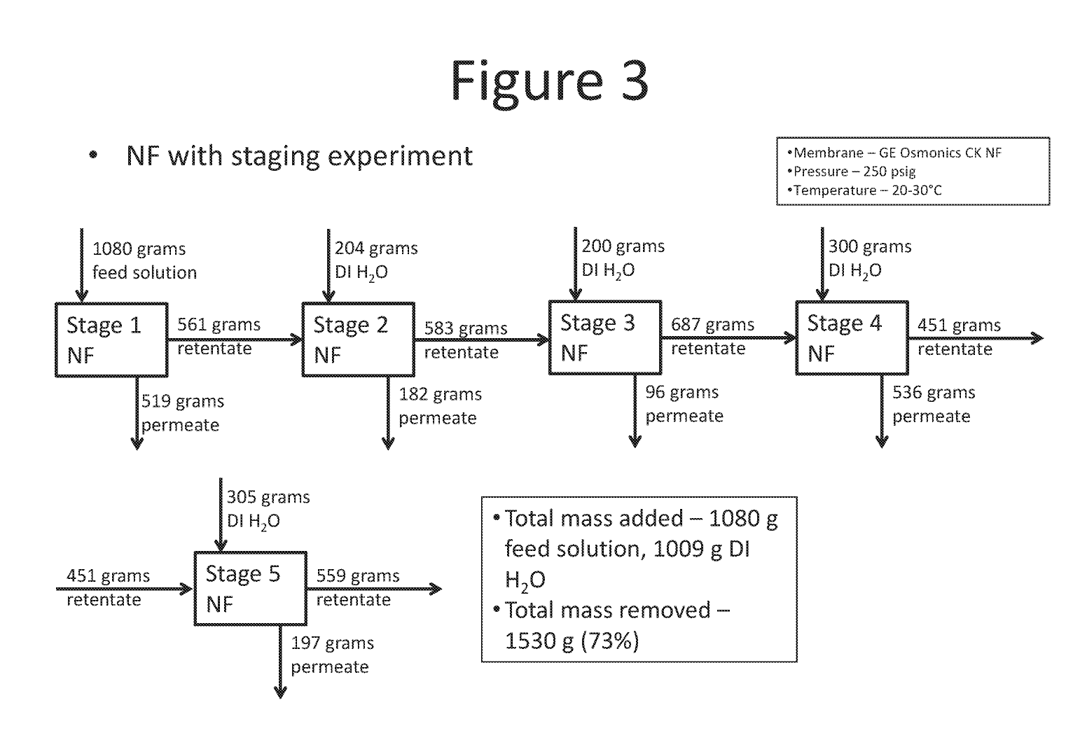

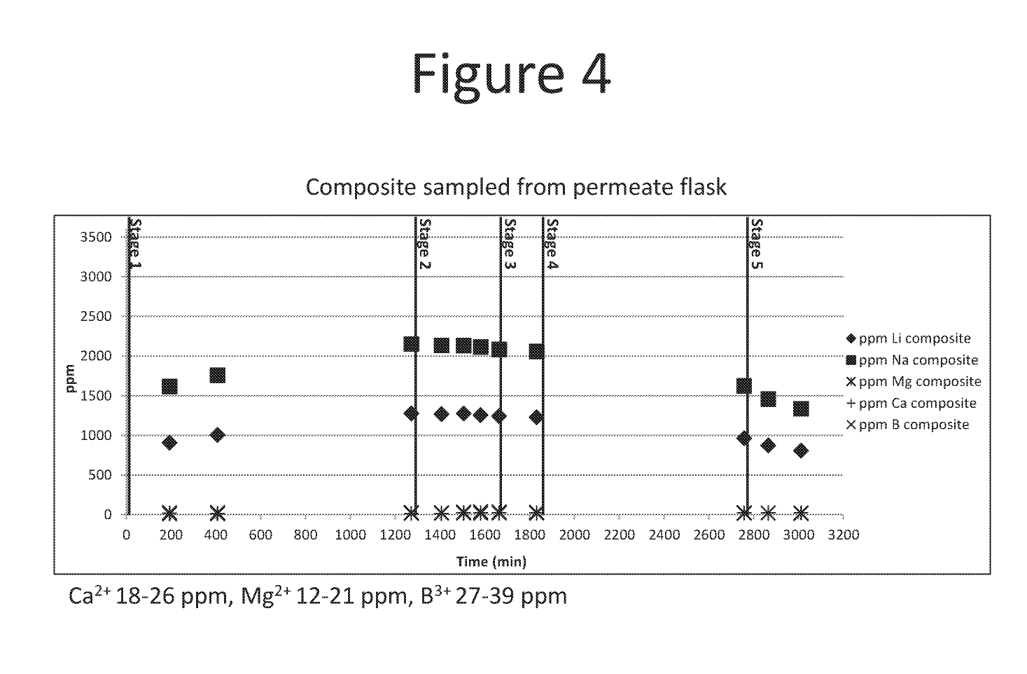

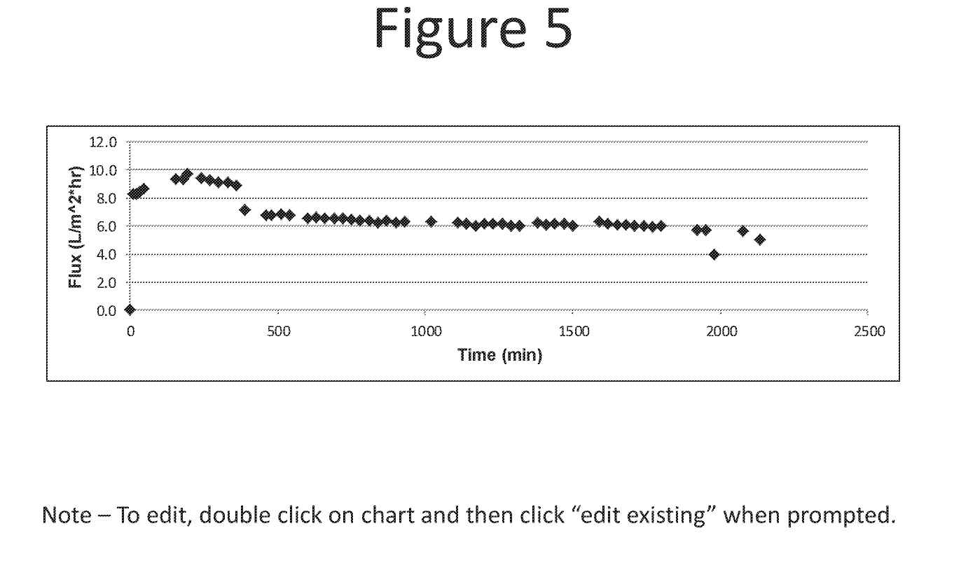

FIG. 3 shows results from an Example which serves as a proof-of-concept test conducted in the laboratory simulating series of nanofiltration operations with dilution of the feed Stream A between each stage. A commercially available nanofiltration membrane (GE Osmonics CK membrane) was used. Temperature was maintained at less than 30° C. The recirculating solution contacted one side of a nanofiltration membrane. As the solution recirculated permeate—Stream B—was collected from the alternate side of the membrane. The permeate weight over time was collected to calculate flux through the membrane. The starting feed solution contained 1.40 wt % LiCl; 0.86 wt % NaCl; 0.038 wt % CaCl₂; 0.108 wt % MgCl₂, and 0.004 wt % B(OH)₃ (all representative concentrations producible from a Magnolia Arkansas Smackover brine stream entering the nanofiltration process). Overall 73% of the solution mass (starting+amount added) was transferred to the permeate through the membrane. As shown in FIG. 4, throughout the experiment, the concentration of each ion in the permeate remained constant (no significant breakthrough of divalent ions). Additionally, FIG. 5 shows that the flux also remained relatively constant during the experiment.

### EXAMPLE 3

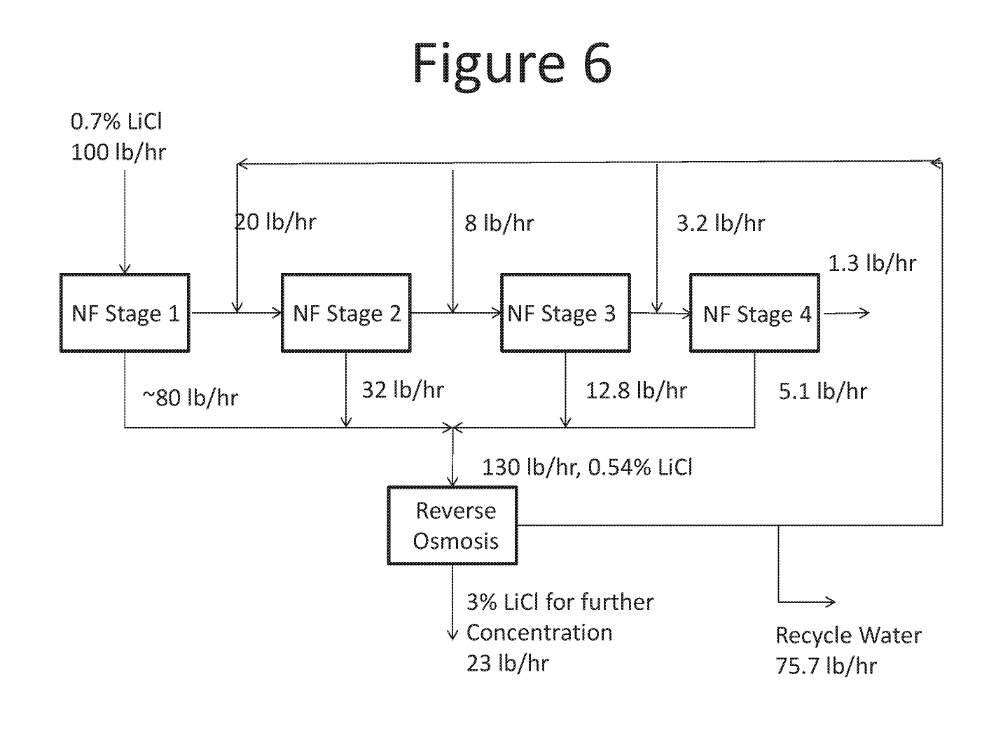

FIG. 6 shows projected staging and dilution of a proposed commercial nanofiltration process based on current laboratory results. It is expected that we will be able to recover 94% of the lithium in the feed stream (Stream A) as permeate in Stream B. Further, with the staging and dilution proposed, we expect to maintain a divalent rejection of ˜90% (less than 10% of divalent ions transferred to permeate).

We turn now to the figures of the drawings.

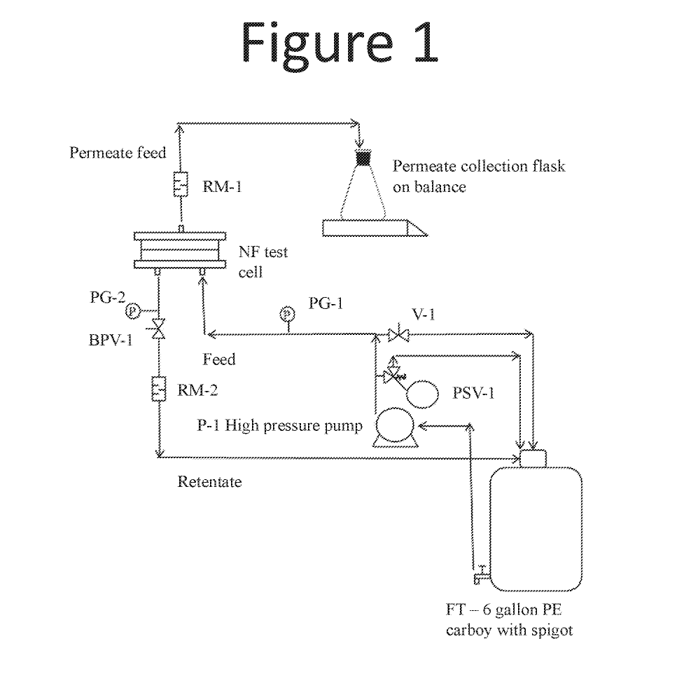

FIG. 1 schematically depicts a standard nanofiltration bench-scale experimental setup such as utilized in the present experimental work. The nanofiltration test cell holds a flat sheet nanofiltration membrane and a spacer. The cell is primarily used for simple membrane evaluation and screening. In the experiments described herein, an aqueous lithium-containing brine feed solution was housed in the 6 gallon polyethylene (PE) carboy with spigot. The solution was recirculated through the nanofiltration test cell via the high pressure pump P-1. The valve was used as a bypass valve if needed. At the nanofiltration test cell, pressure was measured at the inlet and outlet of the cell. As permeate was caused to flow through the nanofiltration membrane and out the top of the test cell, it was collected in a flask on a laboratory balance and its weight recorded. The solution that did not flow through the membrane (retentate) was returned to 6 gallon carboy for recirculation. Pressure in the cell was controlled by a back pressure regulator BPV-1. Temperature was controlled placing PID controlled cooling or heating coils in the 6 gallon carboy containing the brine solution.

FIG. 2 is a graphical presentation showing the percent mass of each of the lithium-containing brine containing species in Example 1 in relation to reaction time. As time increased, the amount of each species transferred to the permeate also increased. One of the key features of this invention is the percentage of lithium chloride transferred to the permeate as compared to the magnesium chloride and calcium chloride species. While greater than 60% of the lithium was transferred to the permeate in this particular experiment, less than 15% of the magnesium chloride and calcium chloride species entered the permeate solution. The example represents an initial proof-of-concept and these were the initial results obtained without further improvements.

Shown in FIG. 3 are details describing a bench-scale experiment to simulate diluting the retentate formed between multiple stages of series operation of the present nanofiltration process. Between each stage, roughly 600 grams of deionized (DI) water was added to the lithium-containing brine solution. Additional relevant results are shown in subsequent FIGS. 4 and 5.

FIG. 4 shows the permeate concentration experimental data from the experiment depicted in FIG. 3. From the graph, it is evident that through dilution between stages, it was possible to maintain a relatively constant permeate profile and separation between the monovalent lithium and divalent magnesium and calcium species. The decline of the lithium species near the end of the graph is a result of the declining lithium available in the retentate solution. This Example represents an initial proof-of-concept and further improvements in such process operations are to be expected.

As seen in FIG. 5, the flux of permeate through the nanofiltration membrane over time is shown graphically for the experiment described in FIG. 3. As a result of the dilution between nanofiltration stages, a relatively constant flux was achieved. The Example again represents an initial proof-of-concept and achievement of further improvements in results are deemed very likely. Higher fluxes can be achieved by increasing the temperature of the aqueous lithium-containing brine solution or by selecting an alternate nanofiltration membrane.

FIG. 6 depicts a sample commercial model of using nanofiltration for divalent removal involving dilution between stages. It is based on the concept shown in FIG. 3, however the model is not a direct correlation to the prior example given (FIGS. 3-5). FIG. 6 assumes 94% of the lithium contained in the initial aqueous lithium-containing brine feed solution is transferred in the permeate while only roughly 35% of the divalent species (magnesium and calcium) are transferred to the permeate. Further improvements in this model of operation are to be expected.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition.

Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

Except as may be expressly otherwise indicated, the article “a” or “an” if and as used herein is not intended to limit, and should not be construed as limiting, a claim to a single element to which the article refers. Rather, the article “a” or “an” if and as used herein is intended to cover one or more such elements, unless the text taken in context clearly indicates otherwise.

This invention is susceptible to considerable variation in its practice. Therefore the foregoing description is not intended to limit, and should not be construed as limiting, the invention to the particular exemplifications presented hereinabove.

1. A process for removing divalent ions comprised at least of Ca²⁺ and Mg²⁺ from a lithium-containing brine, which process comprises
(i) providing an aqueous lithium-containing brine feed comprising at least Ca²⁺ and Mg²⁺ impurities in solution and in a weight ratio of dissolved Li⁺:Ca²⁺ in the range of about 4:1 to about 50:1 wt/wt and in a weight ratio of dissolved Li⁺:Mg²⁺ in the range of about 4:1 to about 50:1;
(ii) subjecting said lithium-containing brine feed to nanofiltration to produce a lithium-containing permeate from which Ca²⁺ and Mg²⁺ components are being removed concurrently; and
(iii) conducting the nanofiltration to cause a separation in which a retentate solution is formed with a total amount of Ca²⁺ and Mg²⁺ of at least 75% as compared to the total amount Ca²⁺ and Mg²⁺ in the original aqueous lithium-containing brine feed and forming an aqueous lithium-containing permeate solution in which the total content of dissolved Ca²⁺ and Mg²⁺ has been decreased such that the total content thereof is 25% or less as compared to the original aqueous lithium-containing brine feed.

2. A process as in claim 1 wherein the aqueous lithium-containing brine used as the feed in (i) has an initial content of at least 200 ppm (wt/wt) of Li⁺, an initial content of Ca²⁺ of at least 25 ppm (wt/wt) and an initial content of Mg²⁺ of at least about 25 ppm (wt/wt).

3. A process as in claim 1 wherein the aqueous lithium-containing brine used as the feed in (i) has an initial content of at least 500 ppm (wt/wt) of Li⁺, an initial content of Ca²⁺ of at least 25 ppm (wt/wt) and an initial content of Mg²⁺ of at least about 25 ppm (wt/wt).

4. A process as in claim 1 wherein the aqueous lithium-containing brine used as the feed in (i) has an initial content of at least 1000 ppm (wt/wt) of Li⁺, an initial content of Ca²⁺ of at least 50 ppm (wt/wt) and an initial content of Mg²⁺ of at least about 50 ppm (wt/wt).

5. A process as in claim 1 wherein the nanofiltration is conducted using nanofiltration membranes which have not been treated with chemical compounds such as polyfunctional amines affecting the solute-removing performance and water permeation performance of particular ionic species through the membranes.

6. A process as in claim 1 wherein the nanofiltration is conducted using at least one series of two or more nanofiltration units arranged in series.

7. A process as in claim 1 wherein the nanofiltration is conducted using at least two or more nanofiltration units arranged in parallel.

8. A process as in an claim 1 wherein the nanofiltration is conducted using one or more nanofiltration units in which the nanofiltration membranes contained therein are cellulose acetate membranes.

9. A process as in claim 1 wherein the nanofiltration is conducted using one or more nanofiltration units in which the nanofiltration membranes contained therein are composed of at least one thin polyamide layer deposited on a polyethersulfone porous layer or a polysulfone porous layer.

10. A process as in claim 1 wherein the nanofiltration units are arranged in series and wherein between some or all nanofiltration units, the lithium-containing feed solution is diluted with an aqueous solution to increase the rate of production of lithium-containing permeate solution while maintaining a minimum separation of 75% between Li⁺ and Mg²⁺ dissolved ions and between Li⁺ and Ca²⁺ dissolved ions.

11. A process as in claim 1 wherein the aqueous lithium-containing brine provided in (i) has a content of at least 500 ppm (wt/wt) of Li⁺, a content of Ca²⁺ of at least 25 ppm (wt/wt) and a content of Mg²⁺ of at least about 25 ppm (wt/wt); and wherein the nanofiltration units are arranged in series and wherein between some or all nanofiltration units, the lithium-containing feed solution is diluted with an aqueous solution to increase the rate of production of lithium-containing permeate solution while maintaining a minimum separation of 75% between Li⁺ and Mg²⁺ dissolved ions and between Li⁺ and Ca²⁺ dissolved ions.

12. A process as in claim 11 wherein the nanofiltration process is conducted using one or more nanofiltration units in which the nanofiltration membranes contained therein are cellulose acetate membranes.

13. A process as in claim 11 wherein the nanofiltration is conducted using one or more nanofiltration units in which the nanofiltration membranes contained therein are composed of a thin polyamide layer deposited on a polyethersulfone porous layer or a polysulfone porous layer.

14. A process as in claim 1 wherein the aqueous lithium-containing brine provided in (i) has a content of at least 1000 ppm (wt/wt) of Li⁺, a content of Ca²⁺ of at least 50 ppm (wt/wt) and a content of Mg²⁺ of at least about 50 ppm (wt/wt); and wherein the nanofiltration units are arranged in series and wherein between some or all nanofiltration units, the lithium-containing feed solution is diluted with an aqueous solution to increase the rate of production of lithium-containing permeate solution while maintaining a minimum separation of 75% between Li⁺ and Mg²⁺ dissolved ions and between Li⁺ and Ca²⁺ dissolved ions.

15. A process as in claim 14 wherein the nanofiltration process is conducted using one or more nanofiltration units in which the nanofiltration membranes contained therein are cellulose acetate membranes.

16. A process as in claim 14 wherein the nanofiltration is conducted using one or more nanofiltration units in which the nanofiltration membranes contained therein are composed of a thin polyamide layer deposited on a polyethersulfone porous layer or a polysulfone porous layer.

17. A process as in claim 1 wherein the nanofiltration is applied to solutions derived from a Smackover brine.

18. A process as in claim 17 wherein the contents of Li⁺, Ca²⁺, and Mg²⁺ in the Smackover Brine are adjusted to provide said weight ratios of dissolved Li⁺:Ca²⁺ and of dissolved Li⁺:Mg²⁺.
